(19) United States
(12) Patent Application Publication
(10) Pub. No.: US 2025/0059724 A1
(43) Pub. Date: Feb. 20, 2025

(54) SKID STEER VEHICLE AND A DRIVE ASSEMBLY FOR A SKID STEER VEHICLE

(71) Applicant: EXVO Electric LTD, Newbliss (IE)

(72) Inventors: Conor Traynor, Newry (GB); Dylan Scott, Newbliss (IE)

(21) Appl. No.: 18/806,910

(22) Filed: Aug. 16, 2024

(30) Foreign Application Priority Data
Aug. 18, 2023 (GB) 2312690.7

(51) Int. Cl. E02F 9/20; B62D 11/04; F16H 37/06; F16H 57/02; F16H 57/021

(52) U.S. Cl. CPC E02F 9/202; F16H 37/065; F16H 57/021; B62D 11/04; F16H 2057/02034; F16H 2057/02052; F16H 2057/02056

(57) ABSTRACT

A skid steer vehicle comprising at least first and second front wheels located on opposing sides of the vehicle; at least first and second rear wheels located on opposing sides of the vehicle; a drive assembly 11 comprising; a first drive means 12 connected directly via a first front drive shaft 13 to a gearbox 14 of the first front wheel; a second drive means 15 connected directly via a second front drive shaft 16 to a gearbox 17 of the second front wheel; and first and second power transfer arrangements 18, 19 coupled to the first and second drive shafts 13, 16 respectively and configured to transfer power from the first and second drive means 12, 15 to the first and second rear wheels respectively.

### FIELD OF THE INVENTION

This invention relates to a skid steer vehicle, and in particular to a skid steer vehicle comprising an efficient drive assembly.

### BACKGROUND OF THE INVENTION

Skid steer vehicles are known and generally comprise a four wheeled vehicle in which the front and rear wheels on either side of the vehicle are mechanically coupled in order that they turn at the same time. Typically, the front and rear wheels on each side of these vehicles are driven by a dedicated motor such that one motor drives the wheels on the right side and one drives the wheels on the left side. The motors are mechanically connected to the front and rear wheels on a given side by an infinite gear member such as a belt and thus both wheels are driven by the belt in a synchronous. However, current solutions lead to drive assemblies that are difficult to assemble/disassemble during manufacture, repair, or maintenance. Existing solutions also often lead to arrangements that can be bulky, which increases the size of the overall vehicles.

It is desirable to provide a skid steer vehicle and a drive assembly for the same which is efficient yet compact and easy to manufacture, repair and maintain.

### SUMMARY OF THE INVENTION

According to the invention there is provided a skid steer vehicle comprising: at least first and second front wheels located on opposing sides of the vehicle; at least first and second rear wheels located on opposing sides of the vehicle; a drive assembly comprising; a first drive means connected directly via a first drive shaft to a gearbox of one of the first front or first rear wheel such that said wheel is directly driven by said first drive means; a second drive means connected directly via a second drive shaft to a gearbox of one of the second front or second rear wheel such that said wheel is directly driven by said first drive means; first and second power transfer arrangements coupled to the first and second drive shafts respectively and configured to transfer power from the first and second drive means to the remaining wheels which are not connected directly to said drive means.

Preferably, the first and second drive means are connected directly to respective first and second front gearboxes of respective first and second front wheels by respective first and second front drive shafts, and the first and second power transfer arrangements are coupled to the first and second front drive shafts respectively and configured to transfer power from the first and second drive means to the first and second rear wheels respectively.

Advantageously, the front wheels are driven directly by the drive means.

Ideally the skid steer vehicle comprises a mirrored drive arrangement on each side of said vehicle, such that the front and rear wheels on the right side thereof are driven by an arrangement that mirrors that of the front and rear wheels on the left side thereof.

Ideally, the first and second power transfer arrangements comprise a first front pulley in operable engagement with the first front drive shaft.

Preferably, the first and second power transfer arrangements comprise a second front pulley in operable engagement with the second front drive shaft.

Ideally, the first and second power transfer arrangements comprise a first rear pulley in operable engagement with a first rear drive shaft.

Preferably, the first and second power transfer arrangements comprise a second rear pulley in operable engagement with a second rear drive shaft.

Ideally, the first and second rear drive shafts are operably engagable with the first and second rear wheels respectively.

Preferably, the first power transfer arrangement comprises a first chain or belt member extending between the first front pulley and the first rear pulley.

Ideally, the second power transfer arrangement comprises a second chain or belt member extending between the second front pulley and the second rear pulley.

Ideally, rotation of the first and second front drive shafts causes synchronous rotation of the first and second rear drive shafts respectively.

Preferably, first and second tensioning members are provided and configured to tension the first and second chain or belt member respectively.

Ideally, the first and second tensioning members comprise first and second idler pulley assemblies. Preferably, the skid steer vehicle further comprises a first front drive bearing associated with the first drive means.

Ideally, the skid steer vehicle further comprises a first front gearbox bearing associated with the gearbox of the first front wheel.

Ideally, the first front drive shaft extends through said first front drive bearing and said first front gearbox bearing to engage with the first drive means and gearbox of the first front wheel respectively.

Preferably, the skid steer vehicle further comprises a second front drive bearing associated with the second drive means.

Ideally, the skid steer vehicle further comprises a second front gearbox bearing associated with the gearbox of the second front wheel.

Ideally, the second front drive shaft extends through said second front drive bearing and said second front gearbox bearing to engage with the second drive means and gearbox of the second front wheel respectively.

Preferably, the first and second drive means are attachable to the chassis of the skid steer vehicle via corresponding first and second drive bearing carrier elements.

Ideally, the first and second drive bearing carrier elements house the first and second front drive bearings respectively.

Preferably, the first and second front gearbox bearings are attachable to the first and second front gearboxes respectively by first and second gearbox bearing carrier elements.

Ideally, the first and second gearbox bearing carrier elements house the first and second front gearbox bearings respectively.

Preferably, the skid steer vehicle further comprises a first front housing element configured to at least partially house and/or connect the first front gearbox, the first gearbox bearing carrier element, the first front drive shaft, and the first front pulley such that at least these components form a sub-assembly configured for attachment and detachment as a single unit.

Ideally, the skid steer vehicle further comprises a second front housing element configured to at least partially house and/or connect the second front gearbox, the second gearbox bearing carrier element, the second front drive shaft, and the second front pulley such that at least these components form a sub-assembly configured for attachment and detachment as a single unit.

Preferably, each of the first and second front housing elements comprise a first end attachable to the first and second front gearbox respectively and a second end attachable to first and second housing mounting plates respectively.

Ideally, the housing mounting plates are attachable to the chassis of the skid steer vehicle.

Preferably, the first and second front drive shafts extend through the first and second front housing elements respectively.

Ideally, the first and second front gearbox bearings and a portion of the first and second front shafts are housed within the first and second front housing elements respectively.

Preferably, the first and second front housing elements are generally cylindrical elements being removably mechanically fixable to the first and second front gearbox respectively at the first ends thereof and removably mechanically fixable to the first and second housing mounting plates respectively at the second ends thereof.

Ideally, the skid steer further comprises first and second rear mounting elements attachable to the chassis of the skid steer vehicle and corresponding first and second rear gear boxes attachable to said first and second rear mounting elements via corresponding first and second rear housing elements.

Ideally, first and second rear drive shafts travel through the first and second rear housing elements respectively, and first and second corresponding rear gearbox bearings are housed by said first and second rear housing elements respectively.

Preferably, the drive means is an electronic motor.

Alternatively, the drive means is an internal combustion motor.

Ideally, the skid steer vehicle comprises one or more brake.

Preferably, the brake is a hydraulic brake.

Alternatively, the brake is an electromagnetic brake.

A drive assembly for a skid steer vehicle, said drive assembly comprising: first and second front drive shafts and first and second rear drive shafts; a first drive means connected directly via a first front or rear drive shaft to a respective first front or rear gearbox on a first side of the vehicle; a second drive means connected directly via the second drive shaft to a second respective front or rear gearbox on a second side of the vehicle; and first and second power transfer arrangements configured to transfer power from the first and second drive means to the remaining drive shafts which not directly connected to said first and second drive means.

Ideally, the first drive means is connected directly via the first front drive shaft to the first front gearbox; the second drive means is connected directly via the second front drive shaft to the second front gearbox; and the first and second power transfer arrangements are coupled to the first and second front drive shafts respectively and configured to transfer power from the first and second motors to first and second rear drive shafts respectively.

According to a third aspect of the invention there is provided a method of assembling a drive assembly for a skid steer vehicle comprising the steps of, in order: providing a drive shaft, a gearbox, a gearbox bearing carrier element, a drive bearing carrier element, and a housing element; assembling said drive shaft into said gearbox bearing carrier element; assembling the gearbox bearing carrier onto said gearbox; mounting a pulley onto said drive shaft; mounting the drive bearing carrier element onto said drive shaft; mounting the gearbox to said housing element, and fixing said housing element to the chassis of a vehicle.

### BRIEF DESCRIPTION OF THE DRAWINGS

An embodiment of the invention is now described by way of example and with reference to the accompanying drawings in which:

FIG. 1 is a perspective view of a drive assembly of a skid steer vehicle;

FIG. 2 is a side view of the drive assembly of FIG. 1;

FIG. 3 is a plan view of the drive assembly of FIG. 1;

FIG. 4 is a front view of the drive assembly of FIG. 1;

FIG. 5 is a an exploded view of a forward right portion of the drive assembly of FIG. 1 and a portion of the chassis of a skid steer vehicle;

FIG. 6 is a perspective view of a portion of the drive assembly of FIG. 1 and a portion of the chassis of a skid steer vehicle;

FIG. 7 is a front view of a forward right portion of the drive assembly and a portion of the chassis of a skid steer vehicle; and

FIG. 8 is a sectional view of FIG. 7.

### DETAILED DESCRIPTION OF THE DRAWINGS

The present teaching will now be described with reference to an exemplary skid steer vehicle It will be understood that the exemplary skid steer vehicle is provided to assist in an understanding of the present teaching and are not to be construed as limiting in any fashion. Furthermore, elements or components that are described with reference to any one Figure may be interchanged with those of other Figures or other equivalent elements without departing from the spirit of the present teaching.

Referring now to the Figures there is illustrated a skid steer vehicle having first and second front wheels located on opposing sides of the vehicle and at least first and second rear wheels located on opposing sides of the vehicle. The skid steer vehicle has a drive assembly 11 comprising a first motor 12 connected directly via a first front drive shaft 13 to a gearbox 14 of the first front wheel and a second motor 15 connected directly via a second front drive shaft 16 to a gearbox 17 of the second front wheel. First and second power transfer arrangements 18, 19 are coupled to the first and second drive shafts 13, 16 respectively and configured to transfer power from the first and second motors to the first and second rear wheels respectively. Advantageously, the front wheels are driven directly by the drive means.

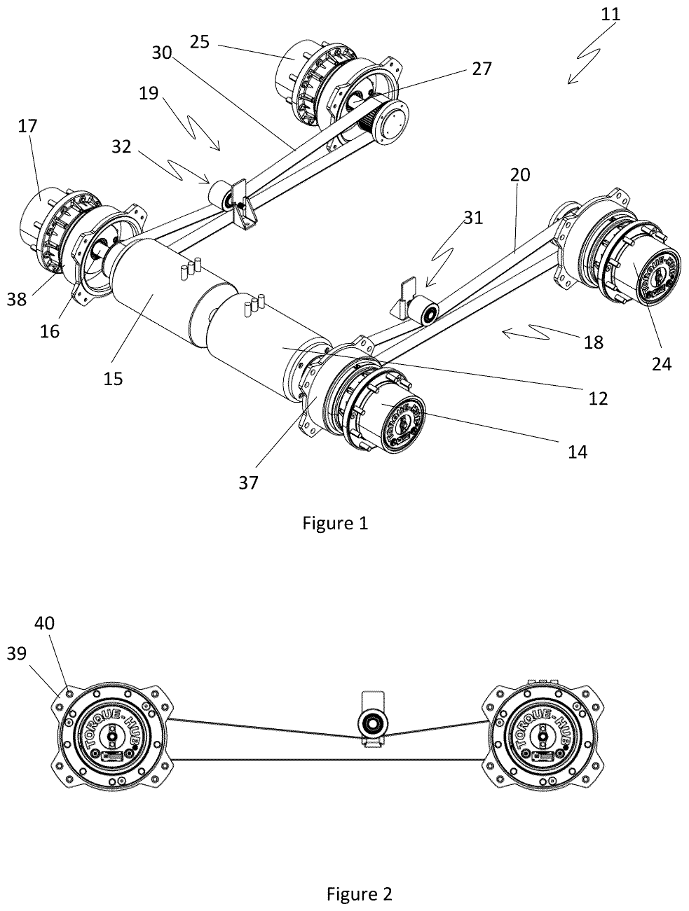

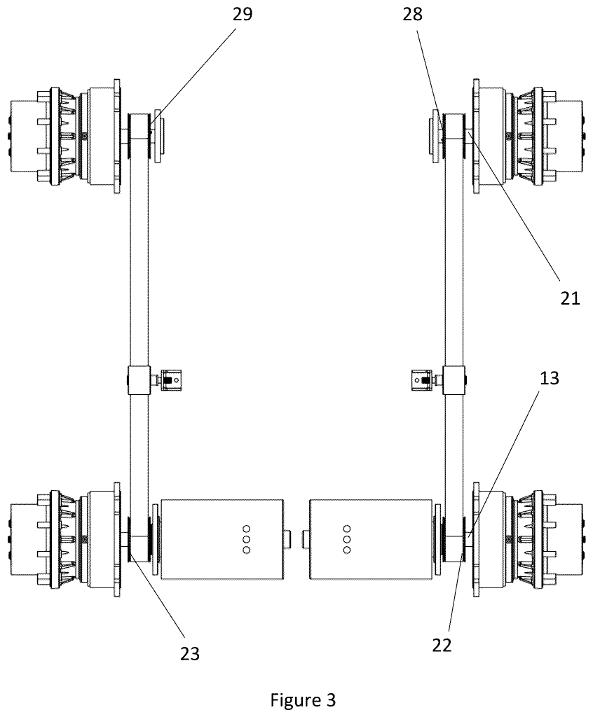

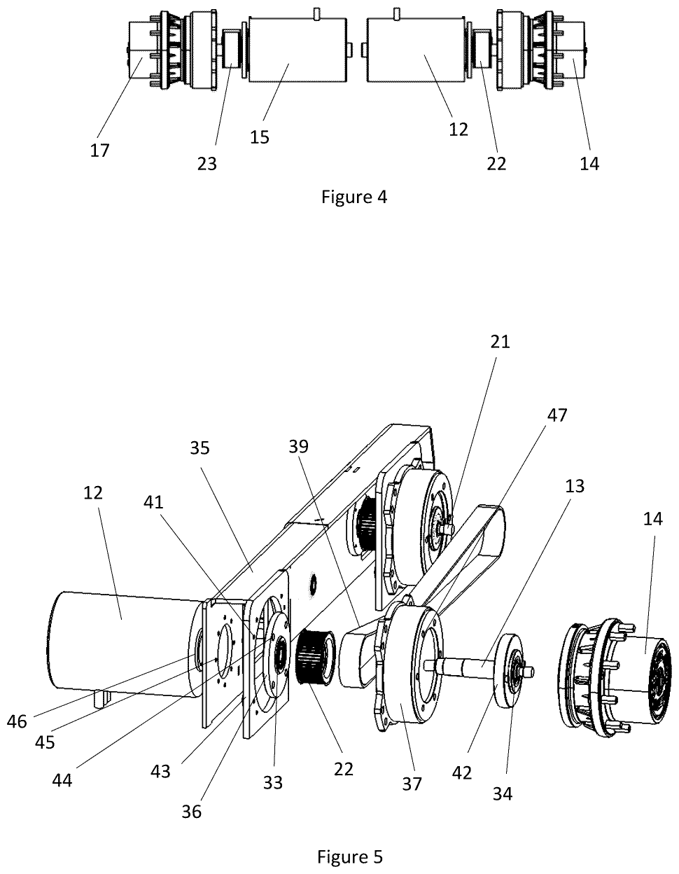

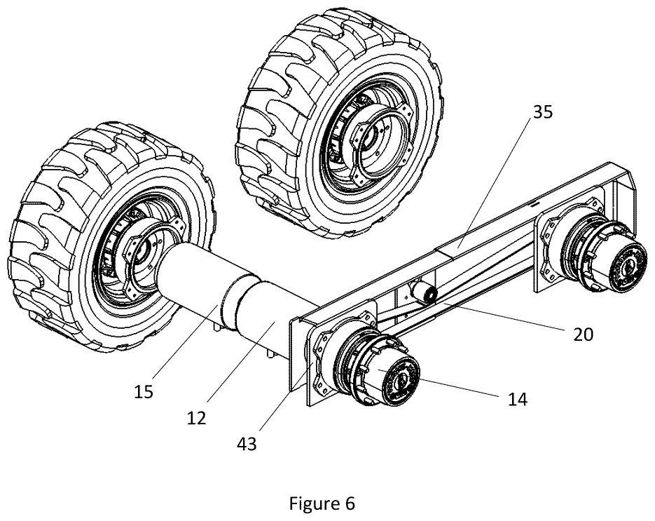

As is evident from FIG. 1, the skid steer vehicle comprises a mirrored drive arrangement on each side of the vehicle, such that the front and rear wheels on the right side thereof are driven by an arrangement that mirrors that of the front and rear wheels on the left side thereof. Therefore, any components discussed herein or shown in the drawings in relation to the right side of the drive assembly 11 are also present on the left side of said drive assembly. More specifically, the right side of the vehicle has a front wheel which is driven directly by the motor 12 via the drive shaft 13, the rear wheel of the right side being connected to the drive shaft 13 of the right side front wheel by the power transfer arrangement 18, said power transfer arrangement comprising a belt 20 and pulley arrangement which transfers the torque of the motor 12 to a drive shaft 21 of the rear right wheel. Thus synchronised motion of the front and rear right wheels may be achieved. The left side of the vehicle comprises the exact same arrangement in mirrored form. For avoidance of doubt, the right side of the vehicle is the right side when viewing the vehicle from a front on perspective.

The first and second motors 12, 15 comprise the right and left motor respectively 12, 15. A first front pulley 22 is provided on the front right drive shaft 13 and a second front pulley 23 is provided on the left front drive shaft 16. The right and left rear wheels of the vehicle are also connected to respective right and left rear gearboxes 24, 25, said gearboxes 24, 25 having respective right and left rear drive shafts 21, 27 connected thereto. A first rear pulley 28 is provided on the right rear drive shaft 21 and a second rear pulley 29 is provided on the left rear drive shaft 27.

The right side power transfer arrangement 18 comprises the first belt 20 extending between the first front pulley 22 and the first rear pulley 28 such that rotation of the front right drive shaft 13 by the right front motor 12 causes rotation of the first front pulley 22 and subsequent movement of the first belt 20 which resultantly causes rotation of the first rear pulley 28 and the associated right rear drive shaft 21. As the right rear drive shaft 21 is in engagement with the right rear gearbox 24, torque from the right front motor 12 is therefore transferred to the right rear gearbox 24 and the right rear wheel can therefore rotate in a synchronised manner with the right front wheel of the vehicle.

The left side of the vehicle operates in the same manner as the right. The left side power transfer arrangement 19 comprises a second belt 30 extending between the second front pulley 23 and the second rear pulley 29 such that rotation of the front left drive shaft 16 by the left front motor 15 causes rotation of the second front pulley 23 and subsequent movement of the second belt 30 which resultantly causes rotation of the second rear pulley 29 and the associated left rear drive shaft 27. As the left rear drive shaft 27 is in engagement with the left rear gearbox 25, torque from the left front motor 15 is therefore transferred to the left rear gearbox 25 and the left rear wheel can therefore rotate in a synchronised manner with the left front wheel of the vehicle. Thus, rotation of the left and right front drive shafts 13, 16 causes synchronous rotation of the left and right rear drive shafts 21, 27 respectively.

As can be seen in FIG. 1, tensioning members 31, 32 are provided and configured to tension the first and second belts 20, 30 respectively. The tensioning members 31, 32 comprise first and second idler pulley assemblies 31, 32. The first idler pulley assembly 31 is positioned to such that the first belt 20 may travel thereunder, the first idler pulley assembly 31 depressing the first belt 20 and increasing the distance the first belt 20 must travel in order to form an infinite loop between the first front pulley 22 and first rear pulley 28, thus tensioning the first belt 20. The second idler pulley assembly 32 is positioned to such that the second belt 30 may travel thereunder, the second idler pulley assembly 32 depressing the second belt 30 and increasing the distance the second belt 30 must travel in order to form an infinite loop between the second front pulley 23 and second rear pulley 29, thus tensioning the second belt 30.

The drive assembly 11 further comprises a first front drive bearing 33 associated with the front right motor 12 and a first front gearbox bearing 34 associated with the right front gearbox 14. The right front drive shaft 13 extends through said first front drive bearing 33 and said front right gearbox bearing 34 to engage with the front right motor 14 and front right gearbox 14 respectively. The front left of the drive assembly mirrors the structure of the front right thereof, the front left comprising a second front drive bearing associated with the front left motor and a second front gearbox bearing associated with the front left gearbox 17. The first and second front drive and gearbox bearings act to support the front right and left drive shafts 13, 16 whilst allowing free rotation thereof.

The front right and left motors 12, 15 are attachable to the chassis 35 of the skid steer vehicle via corresponding right and left drive bearing carrier plates, which also act to house the first and second front drive bearings. Thus one component may be utilised to perform a dual function and thus reduce part count, weight, and size, and increase ease of manufacture, repair, and/or maintenance. The left bearing carrier plate is not shown in the drawings, however said left bearing carrier plate would be similar to the right bearing carrier plate 36 as can be seen in FIG. 5. As noted above, fixing the motors 12, 15 to the chassis 35 via the bearing carrier plates 36, rather than using any additional mounting infrastructure for the motor to chassis mounting, reduces the number of fasteners needed for assembly and allows a more compact design, keeping the width of the drive assembly 11 and overall skid steer vehicle to a minimal. In one embodiment, as can be viewed in FIG. 5, bolts are threaded through bores 44 in the bearing carrier plates 36, onwards through corresponding bores 45 formed in the chassis 35, and are received into bolt receiving threaded bores 46 formed in the motors 12, 15. The right 36 and left drive bearing carrier plates house the first 33 and second front drive bearings respectively. The first 34 and second front gearbox bearings may also be housed in first and second gearbox bearing carrier plates 42 which are attachable to the first and second front gearboxes respectively Again, the drawings show this arrangement in relation to the front right side of the vehicle in FIGS. 5, 7, and 8, however the left side comprises the same features given that it mirrors the right side as discussed above. The drive and bearing carrier plates 36, 42 are plates comprising an aperture formed therein into which the bearing may be mounted.

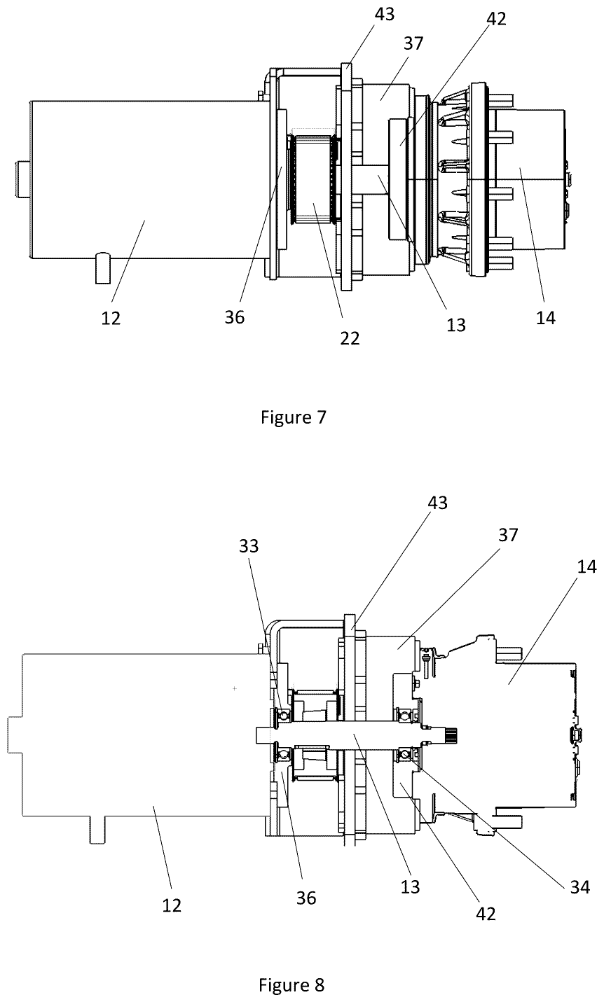

The drive assembly 11 further comprises a front right housing element 37 configured to at least partially house and/or connect the first front gearbox 14, the first gearbox bearing carrier plate, the first front drive shaft 13, and the first front pulley 22 such that at least these components form a sub-assembly configured for attachment and detachment as a single unit. Advantageously, assembly and disassembly are simplified and resultantly maintenance, servicing and/or repair may be made easier and more efficient. Again, as noted herein, the left side of the drive assembly mirrors the right thereof and as such the drive assembly 11 further comprises a front left housing element 38 which is essentially the same as the front right housing element 37 and at least partially houses and/or connect the second front gearbox 17, the second gearbox bearing carrier element, the second front drive shaft 16, and the second front pulley 23 such that these components form a sub-assembly configured for attachment and detachment as a single unit. A first end of the right and left housing elements 37, 38 are attachable to respective right and left housing mounting plates 43, which are in turn fixable to the chassis 35. In some embodiments, the right and left housing elements 37, 38 each comprise a plurality of flanges 39 having bores 40 formed therein which correspond to bores 41 formed in a corresponding housing mounting plate such that the housing elements 37, 38, may be bolted to said corresponding housing mounting plate. A second end of the right and left housing elements 37, 38 is attachable to the respective right and left gearboxes 14, 17, preferably via bolts secured through correspondingly located bores formed in the housing elements 37, 38 and the gearboxes 14, 17. As can be best viewed in FIGS. 7 and 8, the first and second front drive shafts 13, 36 extend through the housing elements 37, 38 respectively, a portion of said drive shafts 13, 16 protruding from each end of the housing elements 37, 38 such that they may engage with the motor and the gearbox. The gearbox bearings, associated carrier plates, and a portion of the drive shafts are housed within the housing elements 37, 38. The housing elements 37, 38 are generally cylindrical elements being removably mechanically fixable to the first and second front gearbox 14, 17 respectively at the first ends thereof and removably mechanically fixable to the corresponding housing mounting plates 43 at the second ends thereof.

The right and left rear sides of the drive assembly comprise essentially the same components as the right and left front sides, with the exception of the motor. In one embodiment, the motor is an electronic motor, however the drive means may be an internal combustion motor/engine. The skid steer vehicle may also comprise one or more brake, which is preferably a hydraulic or electromagnetic brake. The front and rear gearboxes 14, 17, 24, 25, may be planetary gearboxes.

The invention is not limited to the embodiment(s) described herein but can be amended or modified without departing from the scope of the present invention.

1. A skid steer vehicle comprising:
at least first and second front wheels located on opposing sides of the vehicle;
at least first and second rear wheels located on opposing sides of the vehicle;
a drive assembly comprising;
a first drive means connected directly via a first drive shaft to a gearbox of one of the first front or first rear wheel such that said wheel is directly driven by said first drive means;
a second drive means connected directly via a second drive shaft to a gearbox of one of the second front or second rear wheel such that said wheel is directly driven by said first drive means;
first and second power transfer arrangements coupled to the first and second drive shafts respectively and configured to transfer power from the first and second drive means to the remaining wheels which are not connected directly to said drive means.

2. The skid steer vehicle of claim 1, wherein the first and second drive means are connected directly to respective first and second front gearboxes of respective first and second front wheels by respective first and second front drive shafts, and the first and second power transfer arrangements are coupled to the first and second front drive shafts respectively and configured to transfer power from the first and second drive means to the first and second rear wheels respectively.

3. The skid steer vehicle of claim 2, wherein the first and second power transfer arrangements comprise a first front pulley in operable engagement with the first front drive shaft and a second front pulley in operable engagement with the second front drive shaft.

4. The skid steer vehicle of claim 3, wherein the first and second power transfer arrangements comprise a first rear pulley in operable engagement with a first rear drive shaft and a second rear pulley in operable engagement with a second rear drive shaft, the first and second rear drive shafts being operably engagable with the first and second rear wheels respectively.

5. The skid steer vehicle of claim 4, wherein the first and second power transfer arrangements comprise first chain or belt member extending between the first front pulley and the first rear pulley and a second chain or belt member extending between the second front pulley and the second rear pulley such that rotation of the first and second front drive shafts causes synchronous rotation of the first and second rear drive shafts respectively.

6. The skid steer vehicle of claim 5, further comprising first and second tensioning members configured to tension the first and second chain or belt member respectively, preferably the first and second tensioning members comprising an idler pulley assembly.

7. The skid steer vehicle of claim 6, further comprising a comprising a first front drive bearing associated with the first drive means and a first front gearbox bearing associated with the gearbox of the first front wheel, the first front drive shaft extending through said first front drive bearing and said first front gearbox bearing to engage with the first drive means and gearbox of the first front wheel respectively.

8. The skid steer vehicle of claim 7, further comprising a comprising a second front drive bearing associated with the second drive means and a second front gearbox bearing associated with the gearbox of the second front wheel, the second front drive shaft extending through said second front drive bearing and said second front gearbox bearing to engage with the second drive means and gearbox of the second front wheel respectively.

9. The skid steer vehicle of claim 8, wherein the first and second drive means are attachable to the chassis of the skid steer vehicle via corresponding first and second drive bearing carrier elements, said first and second drive bearing carrier elements housing the first and second front drive bearings respectively.

10. The skid steer vehicle of claim 8, wherein the first and second front gearbox bearings are attachable to the first and second front gearboxes respectively by first and second gearbox bearing carrier elements, said first and second gearbox bearing carrier elements housing the first and second front gearbox bearings respectively.

11. The skid steer vehicle of claim 10 comprising a first front housing element configured to at least partially house and/or connect the first front gearbox, the first gearbox bearing carrier element, the first front drive shaft, and the first front pulley such that at least these components form a sub-assembly configured for attachment and detachment as a single unit.

12. The skid steer vehicle of claim 11 comprising a second front housing element configured to at least partially house and/or connect the second front gearbox, the second gearbox bearing carrier element, the second front drive shaft, and the second front pulley such that at least these components form a sub-assembly configured for attachment and detachment as a single unit.

13. The skid steer vehicle of claim 12, wherein each of the first and second front housing elements comprise a first end attachable to the first and second front gearbox respectively and a second end attachable to first and second housing mounting plates respectively, said housing mounting plates being attachable to the chassis of the skid steer vehicle.

14. The skid steer vehicle of claim 13, wherein the first and second front drive shafts extend through the first and second front housing elements respectively and the first and second front gearbox bearings and a portion of the first and second front shafts are housed within the first and second front housing elements respectively.

15. The skid steer vehicle of claim 13, wherein the first and second front housing elements are generally cylindrical elements being removably mechanically fixable to the first and second front gearbox respectively at the first ends thereof and removably mechanically fixable to the first and second housing mounting plates respectively at the second ends thereof.

16. The skid steer vehicle of claim 4, further comprising first and second rear mounting elements attachable to the chassis of the skid steer vehicle and corresponding first and second rear gear boxes attachable to said first and second rear mounting elements via corresponding first and second rear housing elements.

17. The skid steer vehicle of claim 16, wherein the first and second rear drive shafts travel through the first and second rear housing elements respectively, and first and second corresponding rear gearbox bearings are housed by said first and second rear housing elements respectively.

18. A drive assembly for a skid steer vehicle, said drive assembly comprising:
first and second front drive shafts and first and second rear drive shafts;
a first drive means connected directly via a first front or rear drive shaft to a respective first front or rear gearbox on a first side of the vehicle;
a second drive means connected directly via the second drive shaft to a second respective front or rear gearbox on a second side of the vehicle; and
first and second power transfer arrangements configured to transfer power from the first and second drive means to the remaining drive shafts which not directly connected to said first and second drive means.

19. The drive assembly of claim 18, wherein the first drive means is connected directly via the first front drive shaft to the first front gearbox; the second drive means is connected directly via the second front drive shaft to the second front gearbox; and the first and second power transfer arrangements are coupled to the first and second front drive shafts respectively and configured to transfer power from the first and second motors to first and second rear drive shafts respectively.

20. A method of manufacturing a skid steer vehicle comprising the steps of: providing at least first and second front wheels located on opposing sides of the vehicle; providing at least first and second rear wheels located on opposing sides of the vehicle; forming a drive assembly comprising; a first drive means connected directly via a first drive shaft to a gearbox of one of the first front or first rear wheel such that said wheel is directly driven by said first drive means; a second drive means connected directly via a second drive shaft to a gearbox of one of the second front or second rear wheel such that said wheel is directly driven by said first drive means; providing first and second power transfer arrangements coupled to the first and second drive shafts respectively and configured to transfer power from the first and second drive means to the remaining wheels which are not connected directly to said drive means.
